(19) United States
(12) Patent Application Publication
(10) Pub. No.: US 2003/0127459 A1
(43) Pub. Date: Jul. 10, 2003

(54) Saucepan lid having removable centre disc

(76) Inventor: Sin Ting Au, New Territories (HK)

Correspondence Address: Gordon & Jacobson, P.C., 65 Woods End Road, Stamford, CT, 06905, US

(21) Appl. No.: 10/041,274

(22) Filed: Jan. 8, 2002

(51) Int. Cl. B65D 51/16; A47J 36/06

(52) U.S. Cl. 220/367.1; 220/254.1; 220/373; 220/912

(57) ABSTRACT

A lid (10) for a saucepan includes a glass or plastics cover (11) having an opening (23) and a disc (14) secured to the cover and extending across the opening. The disc has a steam aperture (17) through which steam from the saucepan can escape. A handle (13) is secured to the cover by attachment to the disc. The arrangement provides increased strength as compared to a glass or plastics lid having a steam release aperture formed directly in it. The disc (14) can be removed from the opening for cleaning purposes.

### BACKGROUND OF THE INVENTION

The present invention relates to saucepan lids. More particularly, though not exclusively, the invention relates to a glass saucepan lid having a removable centre disc.

Known lids for saucepans or frying pans for example are usually made of glass, or stainless steel. Stainless steel lids do not enable a cook to view the contents of the saucepan during cooking without lifting the lid. Glass lids enable viewing of the contents.

It might be desirable to provide a glass lid for a saucepan having a centre-mounted handle through which steam from the cooking vessel can escape. It might also be desirable to provide a temperature sensing steam vent. In fact this has already been proposed in U.S. Pat. No. 6,006,939. In U.S. Pat. No. 6,006,939, a plastics steam vent moulding co-operates with apertures that are formed directly through the lid itself. One of these apertures receives a screw to secure the plastics handle moulding to the lid. Another aperture provides a through-passage for steam. Where the lid is made of glass, these apertures might be considered as points of weakness. Small apertures through glass can considerably weaken the glass, whereas a larger aperture, say a circular aperture of larger diameter might be considered to be less weakening to the glass lid.

### OBJECTS OF THE INVENTION

It is an object of the present invention to overcome or substantially ameliorate at least one of the above disadvantages and/or more generally to provide a saucepan lid having a centre disc secured into a large aperture formed in the lid and by which a handle is attached to the lid.

It is a further object of the present invention to provide an improved saucepan lid.

It is yet a further object of the present invention to provide a saucepan lid having a centre disc secured to a large centre aperture thereof and by which a handle can be secured to the lid, the centre disc being removable for cleaning purposes.

### DEFINITION

As used herein, the term “saucepan” is intended to mean any cooking vessel having a liquid-receiving vessel with an upper opening to receive a lid. For example, a saucepan can include a frying pan, a rice cooker, a pressure cooker or a steam cooker for example.

### DISCLOSURE OF THE INVENTION

There is disclosed herein a lid for a saucepan, the lid comprising:

a glass or plastics cover having an opening therethrough,

a disc secured to the cover and extending across the opening, and

a handle secured to the disc.

Preferably, the disc has a number of apertures therethrough, one of which receives a fastener to secure the handle to the disc and another of which is a steam-release aperture.

Preferably the handle has incorporated therein a through-passage via which steam passing through the steam-release aperture can escape to atmosphere.

Preferably the handle has incorporated therein a user-manipulable steam-release device.

Preferably the disc is secured to the covered temporarily.

Preferably the disc includes a lip that engages with one side of the cover about the opening.

Preferably there is a sealing ring located between the disc and the opening.

Alternatively, the disc includes a second lip that engages with the other side of the cover about the opening.

### BRIEF DESCRIPTION OF THE DRAWINGS

Preferred forms of the present invention will now be described by way of example with reference to the accompanying drawings, wherein:

FIG. 1 is a schematic perspective illustration of a lid,

FIG. 2 is a schematic inverted perspective illustration of the lid of FIG. 1,

FIG. 3 is a schematic cross-sectional elevational view of an opening in a lid and a disc located in the opening, and

FIG. 4 is a schematic elevational view of a lid fitted with an alternative disc.

### DESCRIPTION OF THE PREFERRED EMBODIMENTS

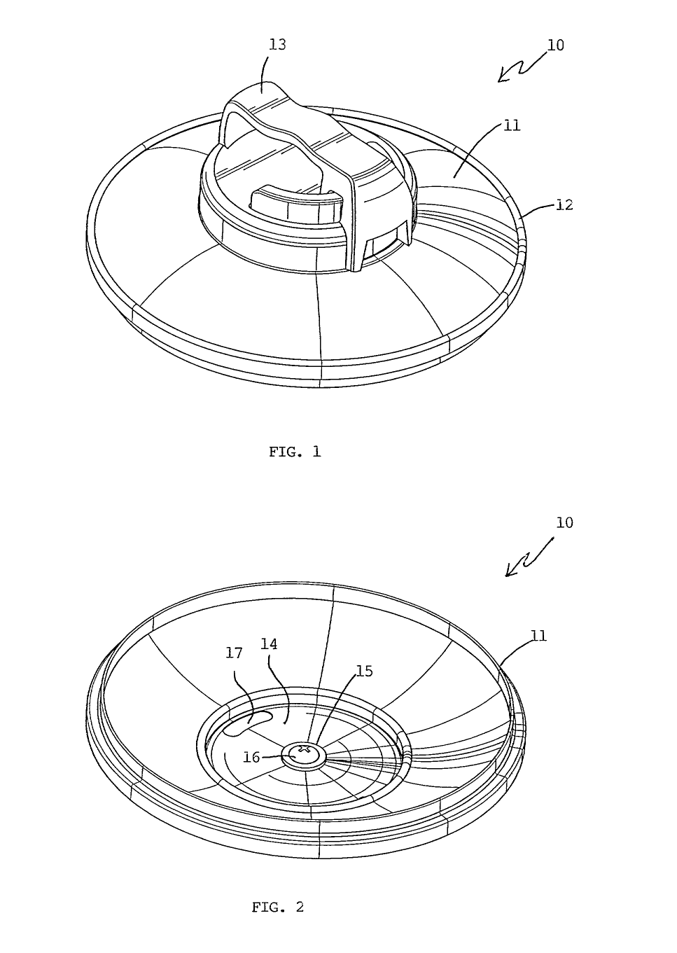

In FIG. 1 of the accompanying drawings, there is schematically depicted a lid 10 for a saucepan. Lid 10 includes a glass cover having a stainless steel rim 12. As an alternative to stainless steel, the rim 12 might be of plastics material or other metal. As an alternative to glass, the cover 11 might be formed of plastics material such as polycarbonate. Preferably, the cover 11 is transparent.

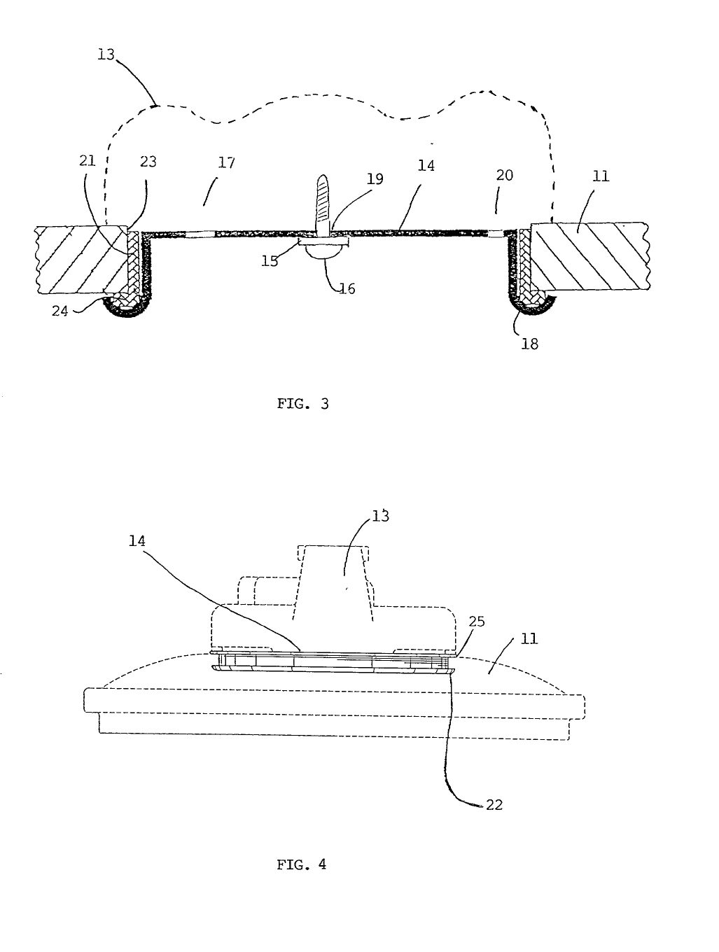

A handle 13 is secured to the cover 11 by means of a disc 14. The disc 14 is typically formed of stainless steel, but might alternatively be formed of strong plastics material. The disc 14 is located within an opening 23 formed in the cover 11 (see FIG. 3).

The handle 13 can have located therein a user-adjustable steam release device such as that disclosed in U.S. Pat. No. 6,006,939.

The disc 14 includes a number of apertures. For example, a steam release aperture 17 of arcuate form is provided near one peripheral edge of the disc. Another aperture 20 is provided, preferably at a diametrically opposed peripheral region of the disc. Aperture 20 receives a lug projecting from an underside of the handle to prevent the handle from rotating. A central aperture 19 (FIG. 3) receives a screw 16 that secures the handle 13 to the disc. In this regard, it should be noted that tightening of screw 16 to the handle 13 draws the handle 13 down upon the upper surface of the cover 11. This in turn pulls upwardly on the disc 14. A washer 15 can be used between the head of 16 and the disc 14.

As shown in FIG. 3, the disc 14 includes a downwardly depending annular lip 18. Between this downwardly depending lip 18 and the opening 23 in cover 11, there is provided a sealing ring 21. Sealing ring 21 might typically be formed of resilient plastics material or rubber for example. The sealing ring 21 is annular in form and includes an outwardly projecting portion 24 that bears against the underside of the cover 11 adjacent to the opening 23. Portion 24 fits snugly between the lip 18 and the cover 11. When the screw 16 is tightened to the handle 13, the lip 18 is drawn upwardly so as to compress the sealing ring 21.

The sealing ring might be adhered to the cover 11 or alternatively to the lip 18.

When it is desired to thoroughly wash the components of the lid 11, the screw 16 can be removed to release the handle 13 from the disc 14. The disc 14 can then be withdrawn from the opening 23 for cleaning. Once the cover, disc and handle are cleaned, the disc 14 can be inserted into the opening 23, the handle 13 placed thereon such that its lug (not shown) passes through aperture 20, and the screw 16 and washer 15 re-affixed.

An alternative permanently secured discs 14 is shown in FIG. 4. This alternative disc 14 includes an upper lip 25 and a lower lip 22 that is crimped down to permanently secure the disc 14 to the cover 11. This embodiment has the advantage of providing the cover 11 with increased strength as compared to a cover having multiple small apertures drilled therein.

It should be appreciated that modifications and alterations obvious to those skilled in the art are not to be considered as beyond the scope of the present invention. For example, any form of handle 13 can be secured to the disc 14. Furthermore, the disc 14 need only have a single aperture, namely only that necessary to receive a screw. Moreover, the steam vent hole 17 and lug-receiving hole 20 may not be needed.

1. A lid for a saucepan, the lid comprising:
a glass or plastics cover having an opening therethrough,
a disc secured to the cover and extending across the opening, and
a handle secured to the disc.

2. The lid of claim 1 wherein the disc has a number of apertures therethrough, one of which receives a fastener to secure the handle to the disc and another of which is a steam-release aperture.

3. The lid of claim 1 wherein the handle has incorporated therein a through-passage via which steam passing through the steam-release aperture can escape to atmosphere.

4. The lid of claim 1 wherein the handle has incorporated therein a user-manipulable steam-release device.

5. The lid of claim 1 wherein the disc includes a lip that engages with one side of the cover about the opening.

6. The lid of claim 1 comprising a sealing ring located between the disc and the opening.

7. The lid of claim 5 wherein the disc includes a second lip that engages with the other side of the cover about the opening.
